(19) United States
(12) Patent Application Publication
(10) Pub. No.: US 2017/0091887 A1
(43) Pub. Date: Mar. 30, 2017

(54) METHOD FOR ACCESSING AN ONLINE ACCOUNT AFTER THE OWNER'S DEATH

(71) Applicant: Yahoo! Inc., Sunnyvale, CA (US)

(72) Inventors: Richard Allinson, Morgan Hill, CA (US); Matthew Jones, San Francisco, CA (US); Annamalai Muruganathan, San Jose, CA (US)

(21) Appl. No.: 14/864,706

(22) Filed: Sep. 24, 2015

(51) Int. Cl. G06Q 50/18; G06Q 40/00

(52) U.S. Cl. CPC G06Q 50/186; G06Q 40/12; G06Q 2220/10

(57) ABSTRACT

In one embodiment, an indication of a number of beneficiaries that are to be granted access to a user account may be received via a graphical user interface. A plurality of sub-keys may be generated according to the number of beneficiaries such that the sub-keys together generate a master key associated with the user account. The master key and/or the plurality of sub-keys may be stored in association with the user account. The plurality of sub-keys may be provided to the beneficiaries or may be provided for distribution to the beneficiaries. A plurality of keys may be received. It may be verified that the plurality of keys, when combined, generate the master key associated with the user account. Access to the user account may be granted based, at least in part, on a result of verifying that the plurality of keys, when combined, generate the master key.

### BACKGROUND OF THE INVENTION

The disclosed embodiments relate generally to computer-implemented methods and apparatus for providing access to an online account. More particularly, the disclosed embodiments relate to computer-implemented methods and apparatus for accessing an online account after the death of the account owner.

Many people have wills that set forth their wishes regarding the distribution of their assets after their death. Typically, wills designate beneficiaries and the property that they will receive. However, people do not typically consider their electronic assets when drafting their wills.

### SUMMARY OF THE INVENTION

An individual may ensure that their beneficiaries will have access to their online accounts upon their death. In one embodiment, an indication of a number of beneficiaries that are to be granted access to a user account may be received via a graphical user interface. A plurality of sub-keys may be generated according to the number of beneficiaries such that the sub-keys together generate a master key associated with the user account. The master key and/or the plurality of sub-keys may be stored in association with the user account. The plurality of sub-keys may be distributed to the beneficiaries or provided for distribution to the beneficiaries. A plurality of keys may be received. It may be verified that the plurality of keys, when combined, generate the master key associated with the user account. Access to the user account may be granted based, at least in part, on a result of verifying that the keys, when combined, generate the master key.

In another embodiment, a device includes a processor, memory, and a display. The processor and memory are configured to perform one or more of the disclosed method operations. In another embodiment, a computer readable storage medium has computer program instructions stored thereon that are arranged to perform one or more of the disclosed method operations.

These and other features and advantages will be presented in more detail in the following specification and the accompanying figures which illustrate by way of example various embodiments.

### BRIEF DESCRIPTION OF THE DRAWINGS

FIG. 1 is a diagram illustrating an example system in which various embodiments may be implemented.

FIG. 2 is a transaction flow diagram illustrating an example method of providing beneficiaries access to an online account.

FIG. 3 is a transaction flow diagram illustrating an example method of providing beneficiaries access to an online account.

FIG. 4 is a schematic diagram illustrating an example client device in which various embodiments may be implemented.

### DETAILED DESCRIPTION OF THE SPECIFIC EMBODIMENTS

Reference will now be made in detail to specific embodiments of the disclosure. Examples of these embodiments are illustrated in the accompanying drawings. While the disclosure will be described in conjunction with these specific embodiments, it will be understood that it is not intended to limit the disclosure to these embodiments. On the contrary, it is intended to cover alternatives, modifications, and equivalents as may be included within the spirit and scope of the disclosure as defined by the appended claims. In the following description, numerous specific details are set forth in order to provide a thorough understanding of the disclosure. The disclosed embodiments may be practiced without some or all of these specific details. In other instances, well known process operations have not been described in detail in order not to unnecessarily obscure the disclosure. The Detailed Description is not intended as an extensive or detailed discussion of known concepts, and as such, details that are known generally to those of ordinary skill in the relevant art may have been omitted or may be handled in summary fashion.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The disclosed embodiments enable individuals to provide beneficiaries access to their online account(s) upon their death. As a result, individuals may control who will be able to access their online account(s) after their death. In addition, individuals may further control the level of access that is granted to the beneficiaries.

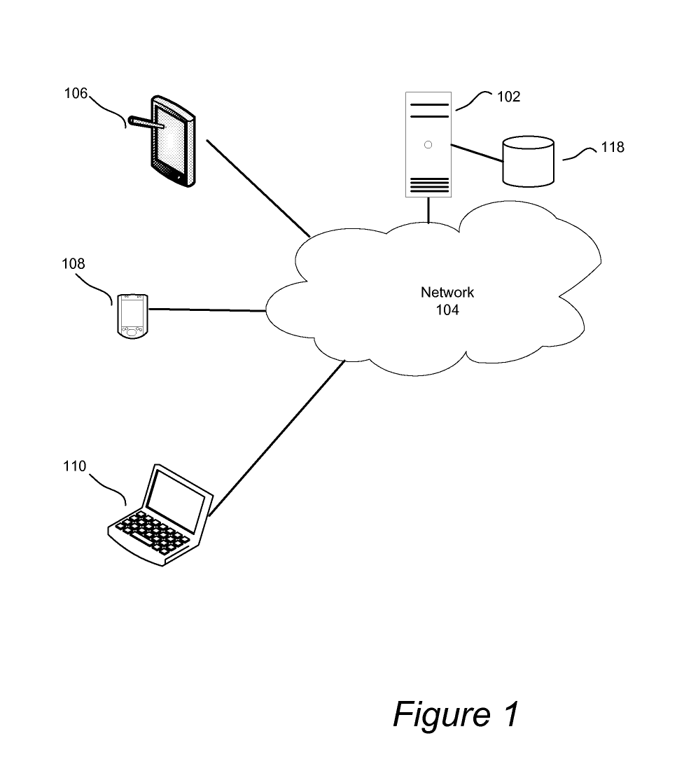

FIG. 1 is a diagram illustrating an example system in which various embodiments may be implemented. The disclosed embodiments may be implemented in some centralized manner. This is represented in FIG. 1 by server(s) 102, which may correspond to multiple distributed devices and data store(s). The server(s) 102 and/or corresponding data store(s) may store user account data, user information, and/or content.

The server(s) 102 may be associated with a web site that provides a variety of services to its users. For example, the server(s) 102 may include a web server, search server, email server, and/or content server. As will be described in further detail below, the web site may be associated with a company that provides various services to users. Example services include, but are not limited to, search services, banking services, email services, and/or phone services.

A plurality of clients 106, 108, 110 may access a web service on a web server via a network 104. The clients 106, 108, 110 may be implemented, for example, via any type of computer (e.g., desktop, laptop, tablet, etc.), media computing platforms (e.g., cable and satellite set top boxes), handheld computing devices (e.g., PDAs), cell phones, or any other type of computing or communication platform.

The network 104 may take any suitable form, such as a wide area network or Internet and/or one or more local area networks (LAN's). The network 104 may include any suitable number and type of devices, e.g., routers and switches, for forwarding search or web object requests from each client to a search or web application and search or web results back to the requesting clients.

The disclosed embodiments may also be practiced in a wide variety of network environments (represented by network 104) including, for example, TCP/IP-based networks, telecommunications networks, wireless networks, etc. Implementations are contemplated in which users interact with a diverse network environment. For example, the network 104 may include a variety of networks, such as a LAN/WAN.

In addition, computer program instructions with which embodiments of the invention may be implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

In accordance with various embodiments, users of the clients 106, 108, 110 may establish or access online accounts via the server(s) 102. More particularly, each of the users may access their online account using a user identifier (e.g., account identifier) and password. A user that has an established online account may be referred to as an account holder or account owner.

An account owner may receive various services from the web site and associated company. For example, such services may include personalized content, banking services, email services, and/or phone services. Upon logging into his or her online account via the server(s) 102, an account owner may view, modify, or delete account information maintained in their online account. In addition, the account owner may access various assets that are accessible via their online account. For example, the account owner of an online account may withdraw or transfer funds from a checking or savings account.

In accordance with various embodiments, an account owner may ensure that their beneficiaries may access their online account after their death. In addition, the account owner may ensure that access to their online account is provided according to a desired access level. The disclosed embodiments may be implemented via the server(s) 102 and/or the clients 106, 108, 110.

The server(s) 102 may maintain a user account for each account holder (i.e., account owner). Examples of information that may be maintained in a user account will be described in further detail below.

In accordance with various embodiments, the server(s) 102 may have access to one or more user logs 118 (e.g., user databases) in which a user account is retained for each of a plurality of users. More particularly, the user account may include public information that is available in a public profile and/or private information. The user logs 118 may be retained in one or more memories that are coupled to the server 102.

The account information for a given user account may include a personal identifier and a password. In addition, the account information may include personal information such as demographic information (e.g., age and/or gender) and/or geographic information (e.g., residence address, work address, zip code, and/or area code). The account information may also indicate an account balance and/or transaction history. In some instances, a transaction history may include a purchase history with respect to one or more products, types of products, services, and/or types of services.

In some embodiments, a user account may include a user profile that is generated or updated, at least in part, by the server(s) 102. A variety of mechanisms may be implemented to support the generation or updating of user profiles including, but not limited to, collecting or mining navigation history, stored documents, tags, or annotations, to provide a few examples.

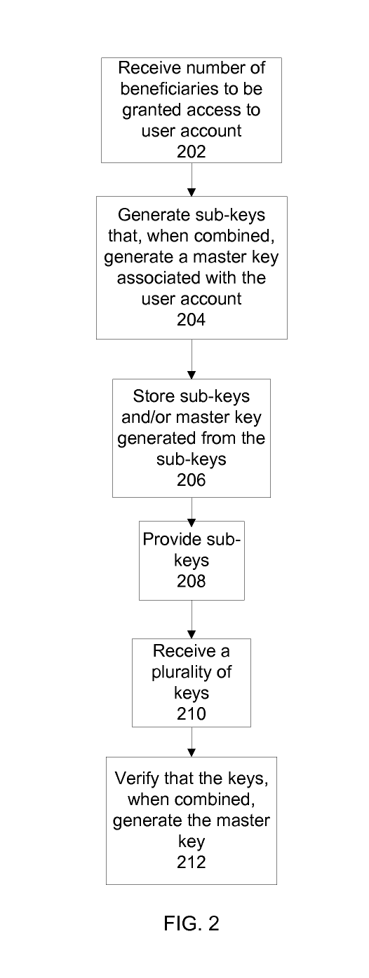

FIG. 2 is a transaction flow diagram illustrating an example method of providing beneficiaries access to an online account. A user may access the web site and log in to their user account. From the user account, the user may select an option to initiate the process of establishing beneficiary access to the user account. More particularly, the system may receive, via a graphical user interface, an indication of a number n of beneficiaries that are to be granted access to the user account at 202. For example, the user may decide that they would like to be able to grant 5 beneficiaries access to their account. The number of beneficiaries may be entered by the user, selected, or otherwise indicated via the graphical user interface.

The system may generate a plurality of sub-keys at 204 according to the number of beneficiaries indicated by the user such that the plurality of sub-keys together generate a master key associated with the user account. A variety of mechanisms may be used to generate the master key from the sub-keys. For example, the sub-keys may, when combined (e.g., appended) in a particular order, form the master key. As another example, the master key may be calculated or otherwise obtained from the sub-keys.

In some embodiments, the system may generate or otherwise obtain a master key, and then generate the sub-keys from the master key. For example, the master key may be generated via a random number generator. As another example, the master key may be obtained via a graphical user interface from the user. The sub-keys may be generated by applying a function to the master key. In other embodiments, the system may generate or otherwise obtain the sub-keys, and then generate the master key from the sub-keys. For example, master key may be generated by applying a function to the sub-keys.

The master key and/or the sub-keys may be stored in association with the user account at 206. In some embodiments, an indication of the mechanism used to generate the sub-keys from the master key, or vice versa, may be stored in association with the user account. For example, the user account may identify a particular function that was applied to the master key to generate the sub-keys. As another example, the user account may identify a particular function to be applied to the sub-keys to generate the master key.

In some embodiments, the user may also indicate a scope of access to the user account that the user wishes to be granted to his or her beneficiaries after his or her death. The scope of access may indicate one or more categories of content items (e.g., electronic mail, photographs) that may be accessed by the beneficiaries. For example, the user may wish to grant the beneficiaries access to online photographs, but not electronic mail. More particularly, the system may receive, via a graphical user interface, an indication of an access scope to be provided to the beneficiaries that are granted access to the user account. An indication of the access scope to be granted to the beneficiaries may be stored in association with the user account.

The sub-keys may be provided at 208. In some embodiments, the sub-keys may be provided (e.g., to the user) for distribution to the user's beneficiaries. For example, the sub-keys may be provided via a graphical user interface. As another example, the sub-keys may be transmitted via electronic mail, short messaging service (SMS), or another suitable mechanism. As yet another example, the user may access the sub-keys by logging in to their user account and selecting a sub-key option from a graphical user interface.

The user need not identify specific beneficiaries at the time that the sub-keys are obtained by the user. Rather, the user may simply distribute the sub-keys among the desired beneficiaries via their preferred means of communication at their own convenience. For example, the user may wish to transmit or provide the sub-keys in person or transmit the sub-keys via electronic mail.

In other embodiments, the system may distribute the sub-keys to the beneficiaries using contact information of the beneficiaries. For example, the sub-keys may be distributed at a time designated by the user. As another example, the sub-keys may be distributed after the user's death.

After the user's death, the system may receive a plurality of keys at 210. For example, the keys may be received via a graphical user interface provided by the system. The keys may be submitted to the system at a single point in time or at separate times. The system may maintain a record of the keys it has received, as well as the number of keys it has received.

In some embodiments, the system may require all of the sub-keys to be submitted at the same time (e.g., via the same web page). As a result, the beneficiaries may be forced to join together to receive a password or token that may be used to access the user account.

The system may verify at 212 that the plurality of keys, when combined, generate the master key associated with the user account. More particularly, the system may apply a particular mechanism to the keys to generate a combined key. The mechanism used to generate the combined key may be identified from the user account. For example, the system may append the received keys in a particular order to generate the combined key. As another example, the system may calculate the combined key from the received keys using a particular function.

The system may then determine whether the combined key is the master key. More particularly, the master key may be retrieved from the user account. Alternatively, the sub-keys may be retrieved from the user account and used to generate the master key. In some embodiments, the mechanism that is used to generate the master key may be identified using information that is stored in association with the user account. In this manner, the system may ensure that the keys that it has received are the same sub-keys that were previously supplied by the system.

The beneficiaries may be granted access to the user's account at 214 after all of the sub-keys have been received. More particularly, access to the user account may be granted after the system has verified that the keys it has received, when combined, generate the master key. Where the user has indicated a desired access scope to be provided to the beneficiaries of the user account, access to the user account may be provided according to the access scope indicated in the user account.

In some embodiments, the system may provide a password or token for use in accessing the user account upon verifying that the keys, when combined, generate the master key associated with the user account. Thus, access to the user account may be provided in response to receiving the password or token. The access may be provided in accordance with the access scope granted to the beneficiaries.

Should the user later decide to change the number of beneficiaries, the user may log in to their user account to modify the number of beneficiaries. The system may revise the plurality of sub-keys associated with the user account, store the revised sub-keys and/or corresponding master key, and provide the revised sub-keys to the user for distribution to the beneficiaries. In some embodiments, the revision of the sub-keys may include the elimination of one or more of the plurality of sub-keys. In other embodiments, the revision of the sub-keys may include the generation of one or more new sub-keys. In yet other embodiments, the revision of the sub-keys may include generation of sub-keys, as described herein.

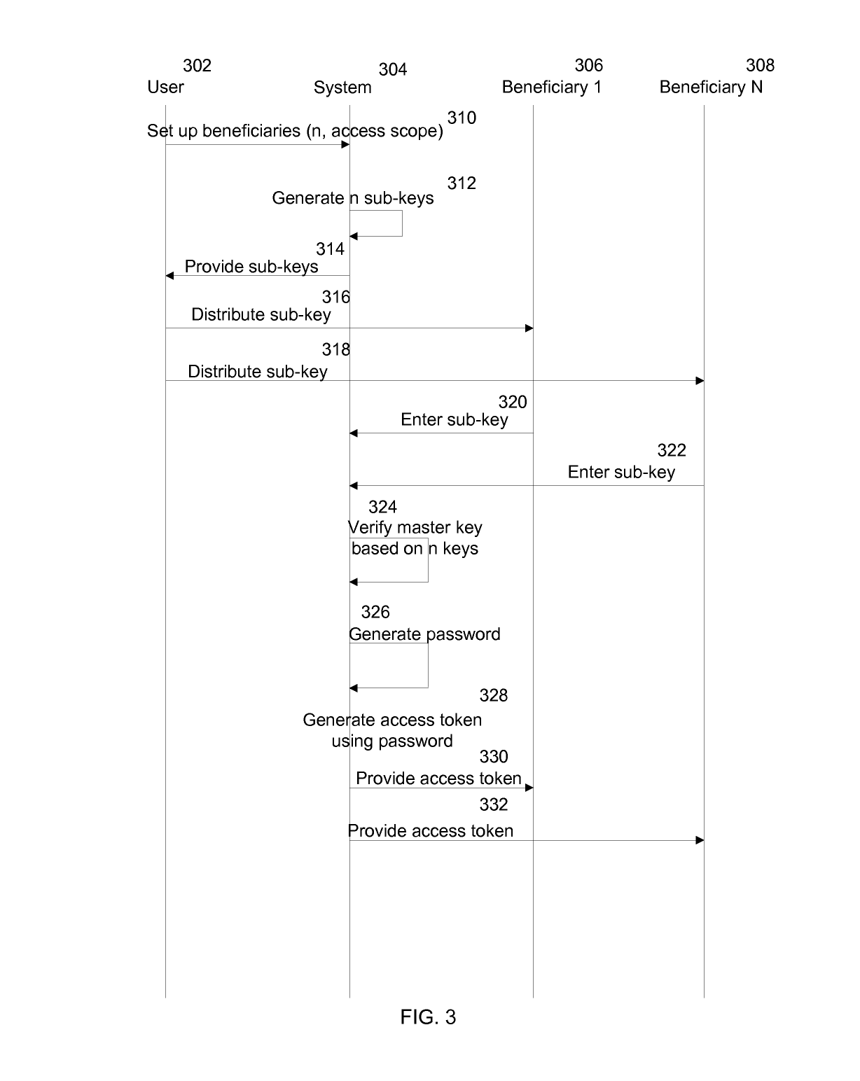

FIG. 3 is a transaction flow diagram illustrating an example method of providing beneficiaries access to an online account. To simplify the description, the following example will be illustrated with reference to two different beneficiaries. However, it is important to note that the user may wish to designate any number of beneficiaries.

Steps performed by a user, a system maintaining user accounts, a first beneficiary, and a second beneficiary will be shown and described with reference to vertical lines 302, 304, 306, and 308, respectively. The user 302 may indicate that he or she wishes to set up access to the user account for beneficiaries of the user at 310. More particularly, the user may indicate a number n of beneficiaries that the user wishes to have access to the user account after the user's death. In this example, the user enters, selects, or otherwise indicates that two beneficiaries will be granted access to the user account. In addition, the user may indicate a desired access scope that the user wishes to grant to the beneficiaries.

The various possible access scopes that are available may vary with the type of user account. For example, where the user account is an electronic mail account, the possible access scopes may include read access and read/write access. In some instances, the beneficiaries may be provided access to only a subset of the information accessible via the user account. As another example, where the user account is associated with a bank account, the possible access scopes may include deposit, withdraw, check writing, and view balance.

The system may generate sub-keys for the beneficiaries at 312 such that the sub-keys, when combined, generate a corresponding master key for the user account. The sub-keys and/or master key may be stored in association with the user account. In this example, the system generates two different sub-keys that, when combined, generate a corresponding master key to the user account. More particularly, the system may generate or otherwise obtain a master key and then generate the sub-keys from the master key. For example, the system may partition the master key to generate the sub-keys. Alternatively, the system may generate the sub-keys, and then generate the master key from the sub-keys. For example, the sub-keys may be appended or combined in a particular manner to generate the corresponding master key.

Each sub-key may be represented in various forms. For example, a sub-key may include a sequence of alphanumeric characters. As another example, a sub-key may include an image or portion thereof.

The sub-keys may be provided at 314. In accordance with various embodiments, the sub-keys may be transmitted to the user for distribution among his or her beneficiaries. The user may then distribute the sub-keys to his or her beneficiaries (e.g., in printed or electronic form). The system may activate the sub-keys upon determining that the user has deceased. For example, the system may determine that the user has deceased upon receiving notification or input from the user's estate attorney, who has a corresponding user identifier and password. In some embodiments, the user may instruct his or her estate attorney to distribute the sub-keys (e.g., electronically or in print form) to the beneficiaries upon the user's death. In some instances, the user may choose to distribute one of the sub-keys to his or her estate attorney. In other embodiments, the system may distribute the sub-keys to the beneficiaries via corresponding contact information (e.g., electronic mail addresses) upon determining that the user has deceased.

The sub-keys may be distributed prior to the user's death. In this example, the user distributes the sub-keys to his or her beneficiaries 306, 308 at 316 and 318, respectively. Alternatively, the sub-keys may be distributed after the user's death.

Each of the user's beneficiaries may receive a single one of the sub-keys. Therefore, each of the user's beneficiaries receives a different sub-key.

After the user's death, the system may receive, via at least one graphical user interface, a plurality of keys (e.g., the sub-keys) from the beneficiaries 306, 308 at 320 and 322, respectively. More particularly, the users may access a beneficiary access web page of the web site and enter their respective sub-keys. For example, the beneficiaries may submit their sub-keys in association with a particular user account or user identifier. In some embodiments, the users may submit their sub-keys at the same time (e.g., via the same web page). In other embodiments, the users may submit their respective sub-keys at separate times. Thus, the system may maintain a record of the sub-keys it has received from the beneficiaries.

The system may verify the master key at 324 based, at least in part, on the keys it has received from the beneficiaries. More particularly, the system may generate a combined key from the keys it has received. The system may then verify that the combined key is the master key for the account, which may be retrieved from the user account or generated from sub-keys retrieved from the user account.

Upon successfully verifying that the keys it has received from the beneficiaries, when combined, generate the master key for the user account, the system may provide a token or password for accessing the user account. The token or password may be provided via a graphical user interface, electronic mail, and/or another form of communication. In some embodiments, the token or password may be retrieved from account data of the user account. For example, the password may be the user password or another password that has been established (e.g., by the user) in association with the user account. In other embodiments, the system may generate the token or password after successfully verifying that the keys it has received, when combined, generate the master key for the user account.

In this example, the system generates a password at 326. The password or a token generated using the password may then be provided. More particularly, the password or token may be provided via a graphical user interface, electronic mail, and/or another communication mechanism. In this manner, the password or token may be provided to the beneficiaries or made available for access by the beneficiaries. Once the beneficiaries have the password or token, any of the beneficiaries may independently access the user account according to the scope of access granted to the beneficiaries.

In this example, the system generates an access token using the password at 328 and provides the access token to the beneficiaries 306, 308 at 330 and 332, respectively. The beneficiaries may then access the user account using the access token according to the granted access scope.

Although the above-described example provides a single token or password for accessing the user account, these examples are merely illustrative. In some instances, the user may wish to grant different access scopes to different sets of the beneficiaries. This may be accomplished, for example, by indicating that multiple sets of sub-keys are desired for the same user account, and indicating the desired access scope in association with the corresponding set of sub-keys. For example, the user may grant access to electronic mail and online photographs to beneficiaries receiving a first set of sub-keys, but only grant access to online photographs to beneficiaries receiving a second set of sub-keys. In some instances, a specific sub-key may be associated with a particular beneficiary or a specific set of sub-keys may be associated with a particular set of beneficiaries to ensure that the proper sub-keys and corresponding access scopes are granted to the desired beneficiaries. By providing different sets of sub-keys to different sets of beneficiaries, multiple different tokens or passwords may be provided to different sets of beneficiaries for the same user account.

The disclosed embodiments enable account owners to ensure that their online accounts may be accessed by their beneficiaries after the death of the account owners. In addition, the account owners may select the appropriate scope of access that will be provided to their beneficiaries.

Network Environment

Access to user accounts may be facilitated in any of a wide variety of computing contexts and may include a variety of networks. A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

Content associated with a user account may be accessed via a distributed system. A distributed system may include a content distribution network. A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

In some embodiments, sub-keys may be distributed in a peer-to-peer network. A peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling devices via an ad hoc arrangement or configuration. A peer-to-peer network may employ some devices capable of operating as both a “client” and a “server.”

The network environment may also include a wireless network that couples client devices with a network. A wireless network may employ stand-alone ad-hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Communications transmitted via a network typically include signal packets. Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

Signal packets may be communicated between devices of a network, such as, for example, to one or more sites employing a local network address. A signal packet may, for example, be communicated over the Internet from a user site via an access device coupled to the Internet. Likewise, a signal packet may be forwarded via network devices to a target site coupled to the network via a network access device, for example. A signal packet communicated via the Internet may, for example, be routed via a path of gateways, servers, etc. that may route the signal packet in accordance with a target address and availability of a network path to the target address.

Various embodiments may be employed via one or more servers. A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

In accordance with various embodiments, user accounts, sub-keys, passwords, and/or tokens may be accessed via a content server. A content server may comprise a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example.

Examples of devices that may operate as a content server include desktop computers, multiprocessor systems, microprocessor-type or programmable consumer electronics, etc.

Client Device

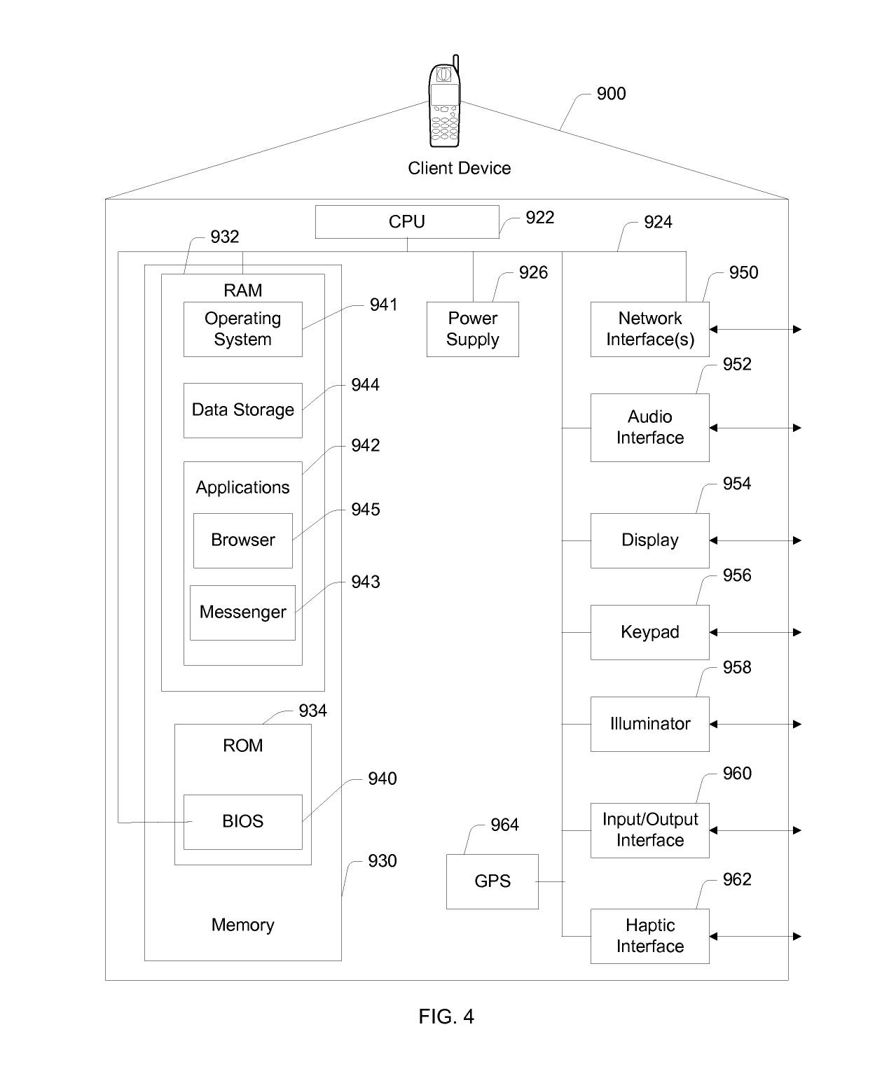

FIG. 4 is a schematic diagram illustrating an example embodiment of a client device in which various embodiments may be implemented. A client device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. A portable device may also be referred to as a mobile device or handheld device.

As shown in this example, a client device 900 may include one or more central processing units (CPUs) 922, which may be coupled via connection 924 to a power supply 926 and a memory 930. The memory 930 may include random access memory (RAM) 932 and read only memory (ROM) 934. The ROM 934 may include a basic input/output system (BIOS) 940.

The RAM 932 may include an operating system 941. More particularly, a client device may include or may execute a variety of operating systems, including a personal computer operating system, such as a Windows, iOS or Linux, or a mobile operating system, such as iOS, Android, or Windows Mobile, or the like. The client device 900 may also include or may execute a variety of possible applications 942 (shown in RAM 932), such as a client software application such as messenger 943, enabling communication with other devices, such as communicating one or more messages, such as via email, short message service (SMS), or multimedia message service (MMS), including via a network, such as a social network, including, for example, Facebook, LinkedIn, Twitter, Flickr, or Google, to provide only a few possible examples. The client device 800 may also include or execute an application to communicate content, such as, for example, textual content, multimedia content, or the like, which may be stored in data storage 944. A client device may also include or execute an application such as a browser 945 to perform a variety of possible tasks, such as browsing, searching, playing various forms of content, including locally stored or streamed video, or games (such as fantasy sports leagues).

The client device 900 may send or receive signals via one or more interface(s). As shown in this example, the client device 900 may include one or more network interfaces 950. The client device 900 may include an audio interface 952. In addition, the client device 900 may include a display 954 and an illuminator 958. The client device 900 may further include an Input/Output interface 960, as well as a Haptic Interface 962 supporting tactile feedback technology.

The client device 900 may vary in terms of capabilities or features. Claimed subject matter is intended to cover a wide range of potential variations. For example, a cell phone may include a keypad such 956 such as a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 964 or other location identifying type capability, or a display with a high degree of functionality, such as a touch-sensitive color 2D or 3D display, for example. The foregoing is provided to illustrate that claimed subject matter is intended to include a wide range of possible features or capabilities.

According to various embodiments, input may be obtained using a wide variety of techniques. For example, input for downloading or launching an application may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input may be obtained in many other ways.

In some embodiments, an identity of the user (e.g., owner) of the client device may be statically configured. Thus, the device may be keyed to an owner or multiple owners. In other embodiments, the device may automatically determine the identity of the user of the device. For instance, a user of the device may be identified by deoxyribonucleic acid (DNA), retina scan, and/or finger print. From the identity of the user, a user profile and/or client profile may be identified or obtained.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, graphical user interfaces to be displayed in association with the disclosed methods, etc.

Because such information and program instructions may be employed to implement the systems/methods described herein, the disclosed embodiments relate to machine readable media that include program instructions, state information, etc. for performing various operations described herein. Examples of machine-readable media include, but are not limited to, magnetic media such as hard disks and magnetic tape; optical media such as CD-ROM disks; magneto-optical media such as optical disks; and hardware devices that are specially configured to store and perform program instructions, such as ROM and RAM. Examples of program instructions include both machine code, such as produced by a compiler, and files containing higher level code that may be executed by the computer using an interpreter.

Computer program instructions with which various embodiments are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques may be implemented in any suitable combination of software and/or hardware system, such as a web-based server or desktop computer system. An apparatus and/or web browser may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
receiving, via a graphical user interface, an indication of a number of beneficiaries that are to be granted access to a user account;
generating a plurality of sub-keys according to the number of beneficiaries such that the plurality of sub-keys together generate a master key associated with the user account;
storing at least one of the master key or the plurality of sub-keys in association with the user account;
providing the plurality of sub-keys;
receiving a plurality of keys;
verifying that the plurality of keys, when combined, generate the master key associated with the user account; and
granting access to the user account based, at least in part, on a result of verifying that the plurality of keys, when combined, generate the master key.

2. The method as recited in claim 1, further comprising:
receiving, via a graphical user interface, an indication of an access scope to be provided to the beneficiaries that are granted access to the user account; and
storing an indication of the access scope in association with the user account;
wherein access to the user account is provided according to the access scope associated with the user account.

3. The method as recited in claim 1, further comprising:
storing, in association with the user account, an indication of a mechanism used to generate the master key from the sub-keys.

4. The method as recited in claim 1, further comprising:
providing a password or token for use in accessing the user account upon verifying that the plurality of keys, when combined, generate the master key associated with the user account.

5. The method as recited in claim 1, further comprising:
applying a mechanism to the plurality of keys to generate a combined key; and
determining whether the combined key is the master key.

6. The method as recited in claim 1, further comprising:
appending the plurality of keys to generate a combined key; and
determining whether the combined key is the master key.

7. The method as recited in claim 1, further comprising:
calculating a combined key from the plurality of keys; and
determining whether the combined key is the master key.

8. A non-transitory computer-readable storage medium storing thereon computer-readable instructions, comprising:
instructions for obtaining, via a graphical user interface, an indication of a number of beneficiaries that are to be granted access to a user account;
instructions for generating a plurality of sub-keys according to the number of beneficiaries such that the plurality of sub-keys together generate a master key associated with the user account;
instructions for storing at least one of the master key or the plurality of sub-keys in association with the user account;
instructions for providing the plurality of sub-keys;
instructions for obtaining, via at least one graphical user interface, a plurality of keys;
instructions for verifying that the plurality of keys, when combined, generate the master key associated with the user account; and
instructions for granting access to the user account based, at least in part, on a result of verifying that the plurality of keys, when combined, generate the master key.

9. The non-transitory computer-readable storage medium as recited in claim 8, further comprising:
instructions for obtaining, via a graphical user interface, an indication of an access scope to be provided to the beneficiaries that are granted access to the user account; and
instructions for storing an indication of the access scope in association with the user account;
wherein access to the user account is provided according to the access scope associated with the user account.

10. The non-transitory computer-readable storage medium as recited in claim 8, further comprising:
instructions for storing, in association with the user account, an indication of a mechanism used to generate the master key from the sub-keys.

11. The non-transitory computer-readable storage medium as recited in claim 8, further comprising:
instructions for providing a password or token for use in accessing the user account upon verifying that the plurality of keys, when combined, generate the master key associated with the user account.

12. The non-transitory computer-readable storage medium as recited in claim 8, further comprising:
instructions for applying a mechanism to the plurality of keys to generate a combined key; and
instructions for determining whether the combined key is the master key.

13. The non-transitory computer-readable storage medium as recited in claim 8, further comprising:
instructions for appending the plurality of keys to generate a combined key; and
instructions for determining whether the combined key is the master key.

14. The non-transitory computer-readable storage medium as recited in claim 8, further comprising:
instructions for calculating a combined key from the plurality of keys; and
instructions for determining whether the combined key is the master key.

15. An apparatus, comprising:
a processor; and
a memory, at least one of the processor or the memory being configured to:
obtain, via a graphical user interface, an indication of a number of beneficiaries that are to be granted access to a user account;
generate a plurality of sub-keys according to the number of beneficiaries such that the plurality of sub-keys together generate a master key associated with the user account;
store the plurality of sub-keys or the master key in association with the user account;
provide the plurality of sub-keys;
receive a plurality of keys;
verify that the plurality of keys, when combined, generate the master key associated with the user account; and
grant access to the user account based, at least in part, on a result of verifying that the plurality of keys, when combined, generate the master key.

16. The apparatus as recited in claim 1, at least one of the processor or the memory being further configured to:
obtain, via a graphical user interface, an indication of an access scope to be provided to the beneficiaries that are granted access to the user account; and
store an indication of the access scope in association with the user account;
wherein access to the user account is provided according to the access scope associated with the user account.

17. The apparatus as recited in claim 1, at least one of the processor or the memory being further configured to:
store, in association with the user account, an indication of a mechanism used to generate the master key from the sub-keys.

18. The apparatus as recited in claim 1, at least one of the processor or the memory being further configured to:
provide a password or token for use in accessing the user account upon verifying that the plurality of keys, when combined, generate the master key associated with the user account.

19. The apparatus as recited in claim 1, at least one of the processor or the memory being further configured to:
apply a mechanism to the plurality of keys to generate a combined key; and
determine whether the combined key is the master key.

20. The apparatus as recited in claim 1, at least one of the processor or the memory being further configured to:
append the plurality of keys or apply a function to the plurality of keys to generate a combined key; and
determine whether the combined key is the master key.
